(19) United States
(12) Patent Application Publication
(10) Pub. No.: US 2009/0147843 A1
(43) Pub. Date: Jun. 11, 2009

(54) METHOD AND APPARATUS FOR QUANTIZATION, AND METHOD AND APPARATUS FOR INVERSE QUANTIZATION

(75) Inventors: Woo-jin HAN, Suwon-si (KR); Bae-keun LEE, Bucheon-si (KR); So-young KIM, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/206,924

(22) Filed: Sep. 9, 2008

(30) Foreign Application Priority Data
Dec. 11, 2007 (KR) 10-2007-0128188

(51) Int. Cl. H04N 7/26

(52) U.S. Cl. 375/240.03; 382/251; 375/E07.139

(57) ABSTRACT

Provided are a quantization method and apparatus and an inverse-quantization method and apparatus for determining quantization steps using lengths of runs that are transform coefficients having consecutive zero values and modifying the transform coefficients. The quantization apparatus can modify quantization steps so that the quantization steps are proportional to lengths of previous runs to quantize significant transform coefficients. As a result, a number of bits generated during coding can be reduced without a great deterioration of video quality.

### CROSS-REFERENCE TO RELATED PATENT APPLICATION

This application claims priority from Korean Patent Application No. 10-2007-0128188, filed on Dec. 11, 2007 in the Korean Intellectual Property Office, the disclosure of which is incorporated herein in its entirety by reference.

### BACKGROUND OF THE INVENTION

1. Field of the Invention

Apparatuses and methods consistent with the present invention relate to quantization and an inverse quantization in a video codec, and more particularly, to determining quantization steps or modifying sizes of transform coefficients using runs that are transform coefficients having consecutive zero values.

2. Description of the Related Art

According to video compression standards such as Moving Picture Experts Group (MPEG), H.26X or the like, video data is compressed through estimation, transformation, quantization, and coding to generate transmission data streams.

In the estimation step, estimation video of the video data to be coded is formed through an intra-estimation using a spatial correlation of video or an inter-estimation using temporal correlation of video.

In the transformation step, error data is transformed into a transform domain using various transform techniques, where the error data is a difference value between the estimation video and original video. Representative examples of transform techniques include Discrete Cosine Transform (DCT), and Wavelet Transform.

The quantization step reduces transformed coefficient values to significant digit bits. Loss of original data occurs due to the reduction in the number of bits. Since all loss compression technologies include quantization steps, it is impossible to completely restore original data. However, compressibility can be increased.

For example, quantization complying with H.264/Advanced Video Coding (AVC) is defined in Equation 1 as:

C′=round[(C+f)/Qs] (1)

Where C denotes an original transform coefficient, f denotes offset, Qs denotes a quantization step, C′ denotes a quantized transform coefficient, and round denotes a round-off operation.

Referring to Equation 1, a transform coefficient is divided into predetermined quantization steps Qs to perform quantization as known in the related art. Here, the quantization steps Qs have values predetermined by quantization parameters (QPs), not variable values according to video compression standards. For example, in H.264/AVC, quantization steps Qs have values predetermined by QPs as shown in Table 1 below.

TABLE 1

| | QP | | | | | | | | | | | |
|---|---|---|---|---|---|---|---|---|---|---|---|---|
| | 0 | 1 | 2 | 3 | 4 | 5 | 6 | 7 | 8 | 9 | 10 | . . . |
| Qs | 0.625 | 0.6875 | 0.8125 | 0.875 | 1 | 1.125 | 1.25 | 1.375 | 1.625 | 1.75 | 2 | . . . |
| | QP | | | | | | | | | | | |
| | . . . | 18 | . . . | 24 | . . . | 30 | . . . | 36 | . . . | 42 | . . . | 48 |
| Qs | | 5 | | 10 | | 20 | | 40 | | 80 | | 160 |

According to quantization technology in the related art as described above, quantization is performed using quantization steps having fixed values in the unit of slice or macroblock. Quantized transform coefficients are arranged in one-dimensional vectors according to a zigzag scan order or the like, and information is coded. Here, the information is necessary for decoding non-zero transform coefficients, runs indicating lengths of consecutive zeros, etc. from the arranged quantized transform coefficients.

Also, in quantization technology in the related art, bits are allocated in proportion to lengths of runs to perform coding. This is because bits are to be allocated to quantized transform coefficients having values of “0”. However, runs that are consecutive transform coefficients having values of “0” do not substantially affect a peak signal to noise ratio (PSNR) of video. Therefore, the allocation of the bits in proportion to the lengths of runs is not efficiently achieved.

### SUMMARY OF THE INVENTION

The present invention provides a quantization method and apparatus for modifying quantization steps in consideration of lengths of runs during quantization of transform coefficients to improve compression efficiency.

The present invention also provides a quantization method and apparatus for modifying sizes of quantized transform coefficients in consideration of lengths of runs to improve compression efficiency.

According to an aspect of the present invention, there is provided a method of quantizing video including: arranging transform coefficients of a transform block having a predetermined size according to a predetermined scan order; counting lengths of runs indicating a number of consecutive zero transform coefficients that are positioned before non-zero transform coefficients of the arranged transform coefficients; and determining quantization steps necessary for quantizing the non-zero transform coefficients, using lengths of runs.

According to another aspect of the present invention, there is provided an apparatus for quantizing video including: an arranger arranging transform coefficients of a transform block having a predetermined size according to a predetermined scan order; a counter counting lengths of runs indicating a number of consecutive zero transform coefficients that are positioned before non-zero transform coefficients of the arranged transform coefficients; and a quantization step determiner determining quantization steps necessary for quantizing the non-zero transform coefficients, using the lengths of runs.

According to another aspect of the present invention, there is provided a method of quantizing video including: arranging quantized transform coefficients of a quantized transform block according to a predetermined scan order; counting lengths of runs indicating a number of quantized consecutive zero transform coefficients that are positioned before quantized non-zero transform coefficients of the arranged quantized transform coefficients; and modifying sizes of the quantized non-zero transform coefficients using the lengths of runs.

According to another aspect of the present invention, there is provided an apparatus for quantizing video including: an arranger arranging quantized transform coefficients of a quantized transform block according to a predetermined scan order; a counter counting lengths of runs indicating a number of consecutive zero transform coefficients that are positioned before non-zero transform coefficients of the arranged quantized transform coefficients; and a modifier modifying sizes of the quantized non-zero transform coefficients using the lengths of runs.

According to another aspect of the present invention, there is provided a method of inverse-quantizing video including: extracting quantized transform coefficients of a current block to be decoded from a received bitstream; counting lengths of runs indicating a number of quantized consecutive zero transform coefficients that are positioned before quantized non-zero transform coefficients of the quantized transform coefficients; determining inverse quantization steps for inverse-quantizing the quantized non-zero transform coefficients, using the runs; and inverse-quantizing the quantized non-zero transform coefficients using the determined inverse quantization steps.

According to another aspect of the present invention, there is provided a method of inverse-quantizing video including: inverse-quantizing a current block to be decoded from a received bitstream; counting lengths of runs indicating a number of inverse-quantized consecutive zero transform coefficients that are positioned before inverse-quantized non-zero transform coefficients of the inverse-quantized transform coefficients; and modifying sizes of the inverse-quantized non-zero transform coefficients using the lengths of runs.

According to an aspect of the present invention, quantization steps for quantizing non-zero transform coefficients can be determined in consideration of lengths of runs to reduce a number of generated bits without a great deterioration of video quality.

Also, sizes of quantized transform coefficients can be modified in consideration of lengths of runs in previous positions to improve compression efficiency of video without a great deterioration of video quality.

### BRIEF DESCRIPTION OF THE DRAWINGS

The above and other aspects of the present invention will become more apparent from the following detailed description of exemplary embodiments thereof with reference to the attached drawings in which:

FIG. 1 is a block diagram of a video coding apparatus including a quantization apparatus according to an exemplary embodiment of the present invention;

FIG. 2 is a block diagram of a quantization apparatus according to an exemplary embodiment of the present invention;

FIG. 3 illustrates a zigzag scan order according to an exemplary embodiment of the present invention;

FIG. 4 is a flowchart of a quantization method according to an exemplary embodiment of the present invention;

FIG. 5 is a block diagram of a quantization apparatus according to another exemplary embodiment of the present invention;

FIGS. 6A and 6B respectively illustrate a number of bits generated when transform coefficients are quantized using a related art quantization method and a number of bits generated when transform coefficients are quantized using a quantization method according to another exemplary embodiment of the present invention;

FIG. 7 is a flowchart of a quantization method according to another exemplary embodiment of the present invention;

FIG. 8 is a block diagram of a video decoding apparatus including an inverse quantization apparatus according to an exemplary embodiment of the present invention;

FIG. 9 is a block diagram of an inverse quantization apparatus according to an exemplary embodiment of the present invention;

FIG. 10 is a flowchart of an inverse quantization method according to an exemplary embodiment of the present invention;

FIG. 11 is a block diagram of an inverse quantization apparatus according to another exemplary embodiment of the present invention; and

FIG. 12 is a flowchart of an inverse quantization method according to another exemplary embodiment of the present invention.

### DETAILED DESCRIPTION OF EXEMPLARY EMBODIMENTS OF THE INVENTION

Exemplary embodiments of the present invention will now be described in detail with reference to the attached drawings.

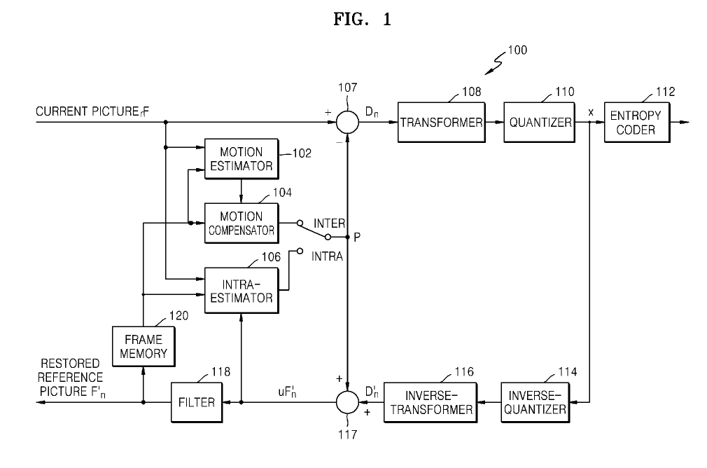

FIG. 1 is a block diagram of a video coding apparatus including a quantization apparatus according to an embodiment of the present invention. Referring to FIG. 1, a video coding apparatus 100 includes a motion estimator 102, a motion compensator 104, an intra-estimator 106, a subtractor 107, a transformer 108, a quantizer 110, an entropy coder 112, an inverse quantizer 114, an inverse transformer 116, an adder 117, a filter 118, and a frame memory 120.

The motion estimator 102 and the motion compensator 104 perform an inter-estimation to search a reference picture for an estimation block of a current block to be coded. If the motion estimator 102 searches the reference picture stored in the frame memory 120 and thus detects an estimation block most similar to the current block, the motion compensator 104 generates an estimation block of the current block based on the detected estimation block.

The intra-estimator 106 generates an estimation block of the current block using values of pixels spatially adjacent to the current block. The values of the adjacent pixels are used as estimation values of the current block according to an optimal intra-estimation direction that is determined in consideration of rate-distortion (R-D) cost.

If the motion compensator 104 or the intra-estimator 106 generates the estimation block of the current block, the subtractor 107 generates a residue that is an error value between the current block and the estimation block. The transformer 10 transforms the residue into a frequency domain to generate and output a transform block. For example, the transformer 108 performs transformation using Discrete Cosine Transform (DCT).

The quantizer 110 quantizes transform coefficients of the transform block to output quantized transform coefficients. As will be described later, according to an aspect of the present invention, the quantizer 110 may arrange the transform coefficients of the transform block in a one-dimensional vector format according to a predetermined scan order and determine quantization steps in proportion to lengths of runs to perform quantization. Also, according to another aspect of the present invention, the quantizer 110 may quantize the transform coefficients of the transform block according to a normal quantization method, arrange the quantized transform coefficients of the quantized transform block in a one-dimensional vector format according to a predetermined scan order, and subtract lengths of previous runs from quantized non-zero transform coefficients to modify sizes of the quantized non-zero transform coefficients.

The entropy coder 112 variable-length-codes the quantized transform coefficients to transform the quantized transform coefficients into a bitstream. Here, binary information may be added to the bistream, wherein the binary information indicates whether quantization has been performed using runs in the block, slice, or frame unit. For example, if binary information “0” indicating a block quantized according to a related art quantization method and binary information “1” indicating a block quantized according to a quantization method of the present invention are added to a bitstream, a decoder may distinguish a method that is used to quantize a block that is decoded using such binary information.

The inverse quantizer 114 and the inverse transformer 116 restore the quantized transform coefficients to a residue, and the adder 116 adds the restored residue to the estimation block to restore the current block. The filter 118 de-blocking-filters the restored current block and stores the de-blocking-filtered block in the frame memory 120 so that the de-blocking-filtered block is used for an inter- or intra-estimation of a next block.

The structure and operation of the quantizer 110 of FIG. 1 will now be described in detail.

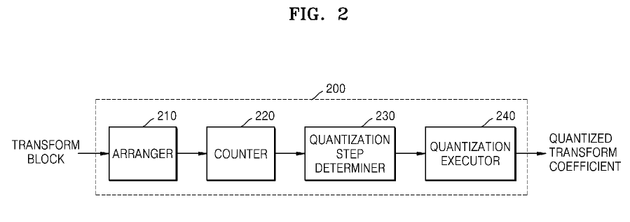

FIG. 2 is a block diagram of a quantization apparatus according to an exemplary embodiment of the present invention. Referring to FIG. 2, a quantization apparatus 200 according to the exemplary embodiment includes an arranger 210, a counter 220, a quantization step determiner 230, and a quantization executer 240.

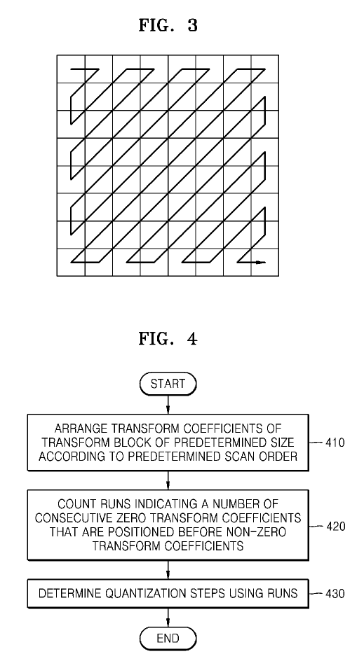

The arranger 210 reads transform coefficients of a transform block according to a predetermined scan order and then arranges the transform coefficients in a one-dimensional vector format. Here, the predetermined scan order may be one of various scan orders including a zigzag scan order as shown in FIG. 3, a raster scan order (not shown), etc.

The counter 220 counts runs indicating a number (or lengths) of transform coefficients that are positioned between previous significant transform coefficients and consecutive zeros, based on non-zero transform coefficients (hereinafter referred to as significant transform coefficients) of the arranged transform coefficients. For example, when transform coefficients of a transform block of predetermined size arranged according to a zigzag scan order are “0 0 −4 7 0 0 0 0 3 . . . ,” the counter 220 counts a number of zero transform coefficients for each of significant transform coefficients “−4,” “7,” and “3”. Here, the zero transform coefficients are positioned between previous significant transform coefficients. Since two consecutive zero transform coefficients are positioned before the significant transform coefficient “−4,” a run of the significant transform coefficient “−4” is “2”. Since zero transformation coefficients are not positioned before the significant transform coefficient “7,” a run of the significant transform coefficient “7” is “0”. Since four consecutive zero transform coefficients are positioned before the significant transform coefficient “3,” a run of the significant transform coefficient “3” is “4”.

The quantization step determiner 230 determines a quantization step necessary for quantizing each significant transform coefficient using a run of each significant transform coefficient. In detail, the quantization step determiner 230 determines a quantization step that is to be applied to quantization of each significant transform coefficient, so that the quantization step is proportional to a run of each significant transform coefficient. For example, when a first quantization step Q_{org} is preset to quantize a transform block according to a QP, a run of a significant transform coefficient is positive integer N, and a predetermined scaling factor is positive real number a, the quantization step determiner 230 determines a second quantization step Q_{new} calculated using Equation 2 below as a final quantization step for quantizing the significant transform coefficient:

Q_{new}=(1+a)*N*Q_{org} (2)

Referring to Equation 2, when a quantization step preset according to the QP is the first quantization step Q_{org}, the first quantization step Q_{org} is changed into a new quantization step, i.e., the second quantization step Q_{new}, that is proportional to a run indicating a length of a zero transform coefficient between a significant transform coefficient and a previous significant transform coefficient. If a run of a significant transform coefficient is “0,” i.e., N=0, the first quantization step Q_{org} is used as it is, instead of determining the second quantization step Q_{new} determined using Equation 2 above as the final quantization step. A method of determining the second quantization step Q_{new} is not limited to Equation 2 above. However, various methods of allowing the second quantization step Q_{new} to be proportional to a length of a run of a quantization step may be used to change the first quantization step Q_{org} into the second quantization step Q_{new}. Also, the quantization step determiner 230 may store new quantization steps such as the second quantization step Q_{new} for each QP in a table such as Table 2 below, where the new quantization steps are preset to be proportional to the length of the run. The quantization step determiner 230 may also determine a quantization step applied to a current significant transform coefficient from Table 2 using a QP and a run as parameters.

TABLE 2

| | run | | | | | | | |
|---|---|---|---|---|---|---|---|---|
| QP | 1 | 2 | 3 | 4 | 5 | 6 | 7 | . . . |
| 0 | 0.75 | 1.5 | 2.25 | 3 | 3.75 | 4.5 | 5.25 | . . . |
| 1 | 0.825 | 1.65 | 2.475 | 3.3 | 4.125 | 4.9 | 5.775 | . . . |

In Table 2 above, it is assumed that quantization steps of Table 1 are used as first quantization steps Q_{org}, and a predetermined scaling factor a is set to “0.2” in Equation 2 above to calculate new quantization steps such as the second quantization step Q_{new}, wherein the new quantization steps are proportional to lengths of runs of significant transform coefficients. As shown in Table 1 above, according to the related art quantization method, if the QP is “0,” and the significant transform coefficient “−4” among the transform coefficients “0 0 −4 7 0 0 0 0 3 . . . ,” is quantized, the significant transform coefficient “−4” is quantized using a quantization step “0.625” that is preset when a current QP is “0”. However, as shown in Table 2 above, according to an exemplary embodiment of the present invention, a size “0.625” of a quantization step preset according to a QP is multiplied by the run “2” of the significant transform coefficient “−4” and weight “1.2” to calculate a new quantization step, i.e., “1.2*2*0.625=0.75”. The new quantization step “0.75” is determined as a final quantization step for quantizing the significant transform coefficient “−4”.

Referring to FIG. 2 again, the quantization executor 240 quantizes significant transform coefficients using determined quantization steps and outputs a number of quantized transform coefficients.

FIG. 4 is a flowchart of a quantization method according to an embodiment of the present invention. In operation 410, transform coefficients of a transform block having a predetermined size are arranged in a predetermined scan order. As previously described, the predetermined scan order may be a zigzag scan order, a raster scan order, or the like.

In operation 420, runs indicating a number of consecutive zero transform coefficients are counted. Here, the consecutive zero transform coefficients are positioned before non-zero transform coefficients of the arranged transform coefficients.

In operation 430, quantization steps for quantizing significant transform coefficients are determined using the counted runs. As previously described, the quantization steps of the significant transform coefficients are set to be proportional to lengths of the runs. For example, as in Equation 2, a quantization step preset according to a QP may be multiplied by a predetermined weight and a length of a run to determine a new quantization step according to the related art quantization method. Here, if the length of the run is “0,” i.e., a significant transform coefficient is positioned before a significant transform coefficient to be currently quantized, a pre-set quantization step may be used as it is, instead of determining an additional new quantization step.

FIG. 5 is a block diagram of a quantization apparatus according to an exemplary embodiment of the present invention. Referring to FIG. 5, a quantization apparatus 500 according to the present exemplary embodiment includes a quantization executor 510, an arranger 520, a counter 530, and a modifier 540.

Similarly to the related art quantization method, the quantization executor 510 quantizes a transform block using a preset quantization step to generate a quantized transform block.

The arranger 520 arranges quantized transform coefficients of the quantized transform block in a one-dimensional vector format according to a predetermined scan order. Here, like the predetermined scan order used by the arranger 210 of FIG. 2, the predetermined scan order of the present exemplary embodiment may be a zigzag scan order, a raster scan order, or the like.

The counter 530 counts runs indicating a number (lengths) of consecutive zero transform coefficients that are positioned before significant transform coefficients of the arranged quantized transform coefficients.

The modifier 540 modifies sizes of the significant transform coefficients using the runs. In detail, the modifier 540 subtracts the lengths of the runs from a size of a current significant transform coefficient to modify a size of a significant transform coefficient. When quantized transform coefficients of a quantized transform block of predetermined size arranged according to a zigzag scan order are “0 0 −4 7 0 0 0 0 3 . . . ,” the modifier 540 subtracts a length of a previous run from absolute values of significant transform coefficients “−4,” “7,” and “3” to modify sizes of the significant transform coefficients “−4,” “7,” and “3”. In other words, since a run of the significant transform coefficient “−4” is “2,” the run “2” is subtracted from an absolute value “4” of the significant transform coefficient “−4”. Since a run of the significant transform coefficient “7” is “0,” the significant transform coefficient “7” is maintained as it is. Since a run of the significant transform coefficient “3” is “4,” the run “4” is subtracted from an absolute value “3” of the significant transform coefficient “3”. Here, if a run is greater than a size of an absolute value of a current significant transform coefficient and thus a subtraction result value is a negative number like the significant transform coefficient “3,” “0” is substituted for the current significant transform coefficient. In summary, the modifier 540 modifies a size of each significant transform coefficient using Equation 3:

M_{new}=max(0,M_{org}−R) (3)

Wherein M_{org} denotes an input quantized significant transform coefficient, R denotes a run of a significant transform coefficient, and M_{new} denotes a modified quantized significant transform coefficient. As shown in Equation 3, if a length of a run is greater than an absolute value of a significant transform coefficient, “0” is substituted for the significant transform coefficient. As described above, the modifier 540 modifies significant transform coefficients of the input quantized transform coefficients “0 0 −4 7 0 0 0 0 3 . . . ” to output transform coefficients “0 0 −2 7 0 0 0 0 0 . . . .” Sizes of significant transform coefficients can be reduced using lengths of runs to reduce a number of bits allocated to the significant transform coefficients. Also, if the lengths of the runs are long, “0” may be substituted for the effective coefficients. Even in this case, the significant transform coefficients less affect a PSNR. However, bits can be saved during the substitution of “0” for the significant transform coefficients having the long lengths of run. As a result, a number of generated bits can be reduced without a great deterioration of video quality.

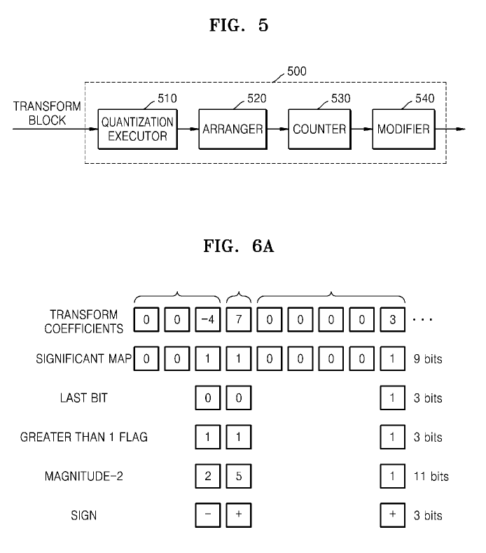

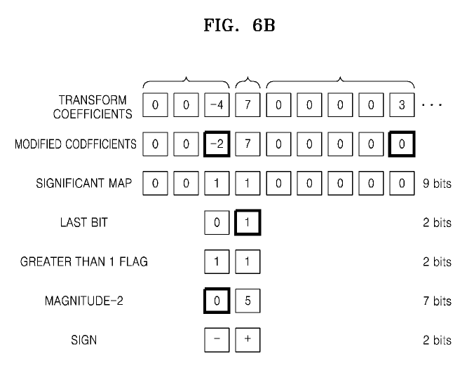

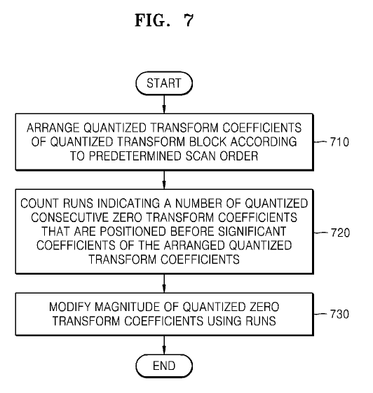

FIGS. 6A and 6B respectively illustrate a number of bits generated when transform coefficients are quantized using a related art quantization method and a number of bits generated when transform coefficients are quantized using a quantization method according to another exemplary embodiment of the present invention. In other words, FIG. 6A illustrates the number of bits generated using the related art quantization method, and FIG. 6B illustrates the number of bits generated using the quantization method of the present invention.

Referring to FIGS. 6A and 6B, “Significant map” is required to indicate whether each transform coefficient is a significant transform coefficient. Thus, one bit is allocated to each of the transform coefficients. “Last bit” indicates whether each significant transform coefficient is a last significant transform coefficient. one bit is allocated to each significant transform coefficient. “Greater than 1 flag” indicates significant transform coefficients, and one bit is allocated to each of the significant transform coefficients. If an absolute value is greater than “1,” “1” is allocated to each of the significant transform coefficients. If the absolute value is less than or equal to “1,” “0” is allocated to each of the significant transform coefficients. “Magnitude-2” indicates values that are obtained through subtractions of “2” from absolute values of significant transform coefficients. “Magnitude-2” is used to reduce sizes of significant transform coefficients greater than “1”. In FIGS. 6A and 6B, result values of “Magnitude-2” are bits generated using ex-golomb codes. “Sign” indicates signs of significant transform coefficients, and one bit is allocated to each of the significant transform coefficients. “Significant map,” “Last Bit,” “Greater than 1 flag,” “Magnitude-2,” and “Sign” are coded to code transform coefficients. As shown in FIG. 6A, according to the related art quantization method, 9 bits are needed to code “Significant map”, 3 bits are needed to code “Last Bit”, 3 bits are needed to code “Greater than 1 flag”, 11 bits are needed to code “Magnitude-2”, and 3 bits are needed to code “Sign”. Thus, “9+3+3+11+3=29” bits must be allocated to code transform coefficients such as “0 0 −4 7 0 0 0 0 3”.

However, in the exemplary embodiment, the modifier 540 can reduce sizes of significant transform coefficients using lengths of runs to reduce a number of bits generated when quantized transform coefficients are coded. In other words, as shown in FIG. 6B, transform coefficients “0 −4 7 0 0 0 0 3 . . . ” are modified into transform coefficients “0 0 −2 7 0 0 0 0 0 . . . ” using lengths of previous runs. If coding is performed using the modified transform coefficients “0 0 −2 7 0 0 0 0 0 . . . ,” the original significant transform coefficient “3” that is a last bit is modified into “0”. Thus, coding is performed only to the significant transform coefficient “7” to code “Last bit” and “Greater than 1 flag”. As a result, two bits are saved. Also, a length of a run is subtracted to code “Magnitude-2” to reduce sizes of significant transform coefficients. Thus, four bits are saved compared to the related art quantization method. In other words, in the related art quantization method, a total of 29 bits are needed to code quantized transform coefficients “0 0 −4 7 0 0 0 0 3”. However, in the quantization method of the present invention, “9+2+2+7+2=22” bits are needed to code quantized transform coefficient “0 0 −4 7 0 0 0 0 3”. As a result, a number of bits necessary for coding quantization transform coefficients can be saved compared to the related art quantization method.

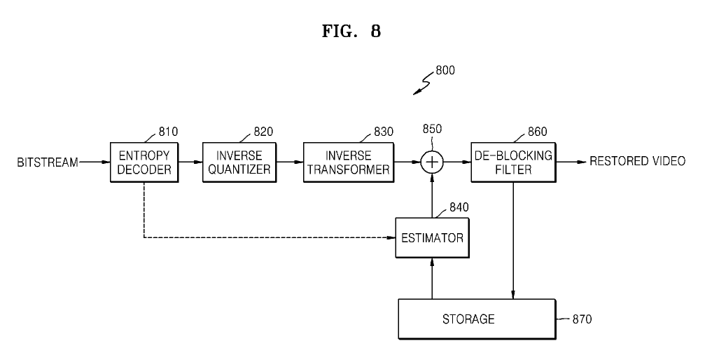

FIG. 7 is a flowchart of a quantization method according to another embodiment of the present invention. Referring to FIG. 7, in operation 710, quantized transform coefficients of a quantized transform block are arranged according to a predetermined scan order. Here, the quantized transform block may be generated using one of various quantization methods including a related art quantization method, a quantization method of the previous exemplary embodiment of the present invention, etc.

In operation 720, runs indicating a number of quantized consecutive zero transform coefficients are counted. Here, the quantized consecutive zero transform coefficients are positioned before significant transform coefficients of the arranged quantized transform coefficients.

In operation 730, sizes of the significant transform coefficients are modified using the runs. As described above, lengths of the runs are subtracted from absolute values of the significant transform coefficients to modify the sizes of the significant transform coefficients. Here, only the sizes of the significant transform coefficients are basically modified, but signs of the significant transform coefficients are not modified. However, if the lengths of previous runs are greater than the absolute values of the significant transform coefficients and thus the subtraction result values are negative numbers, “0” is substituted for the significant transform coefficients. Also, when the sizes of the significant transform coefficients are modified, predetermined offset values may be added to or subtracted from the significant transform coefficients. In this case, the predetermined offset values may be pre-set equally in a coding side and a decoding side.

FIG. 8 is a block diagram of a video decoding apparatus including an inverse quantization apparatus according to an exemplary embodiment of the present invention. Referring to FIG. 8, a video decoding apparatus 800 includes an entropy decoder 810, an inverse quantizer 820, an inverse transformer 830, an estimator 840, an adder 850, a de-blocking filter 860, and a storage 870,

The entropy decoder 810 entropy-decodes a coded bitstream to extract quantized transform coefficients, motion vectors, etc.

The inverse quantizer 820 inverse-quantizes the quantized transform coefficients extracted by the entropy decoder 810 to output inverse-quantized transform coefficients. The structure and operation of the inverse quantizer 820 will be described later.

Adder 850 adds a predictor output from the estimator 840 to video data inverse-transformed by the inverse transformer 820 and outputs the addition result. Here, the inverse-transformed video data corresponds to a residue that is an error value. Thus, a restored residue may be added to the predictor to restore original video.

The de-blocking filter 860 filters the restored video generated by the adder 850 to remove a blocking phenomenon occurring due to quantization from the restored video and outputs the filtered data to the storage 870. Alternatively, the de-blocking filter 830 may be omitted.

The storage 870 stores the inverse-transformed video data or the filtered data in the frame unit. The restored video stored in the storage 870 is output after a predetermined time delay and then used for an inter- or intra-estimation.

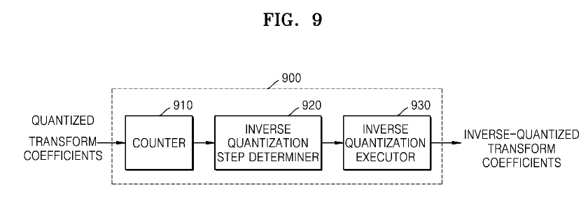

FIG. 9 is a block diagram of an inverse quantization apparatus according to an exemplary embodiment of the present invention. Referring to FIG. 9, an inverse quantization apparatus 900 according to the exemplary embodiment includes a counter 910, an inverse quantization step determiner 920, and an inverse quantization executor 930.

The counter 910 counts runs indicating a number of quantized consecutive zero transform coefficients that are positioned before significant transform coefficients of quantized transform coefficients of a current block that is decoded and extracted by the entropy decoder 810.

The inverse quantization step determiner 920 determines inverse quantization steps for inverse-quantizing the significant transform coefficients using the counted runs. Like the quantization step determiner 230 of FIG. 2, the inverse quantization step determiner 920 determines sizes of the inverse quantization steps for inverse-quantizing quantized non-zero transform coefficients so that the sizes of the inverse quantization steps are proportional to the runs. For example, when a first inverse quantization step IQ_{org} is preset to inverse-quantize a transform block according to a QP, a run is positive integer N, and a is a predetermined scaling factor, a second inverse quantization step IQ_{new} is calculated as in Equation 4 below and then determined as a final inverse quantization step.

IQ_{new}=(1+a)*N*IQ_{org} (4)

Similarly to a quantization apparatus described above according to an exemplary embodiment of the present invention, the inverse quantization step determiner 920 may store quantization steps in a predetermined table according to QPs and lengths of runs. Next, the inverse quantization step determiner 920 may decode inverse-quantized transform coefficients and simultaneously determine inverse quantization steps for inverse-quantizing significant transform coefficients using the lengths of the counted runs.

The inverse quantization executor 930 inverse-quantizes quantized significant transform coefficients using the determined final inverse quantization step. In contrast to quantization processes, the inverse-quantized significant transform coefficients may be multiplied by a predetermined weight and the determined final quantization step to calculate the inverse quantization processes.

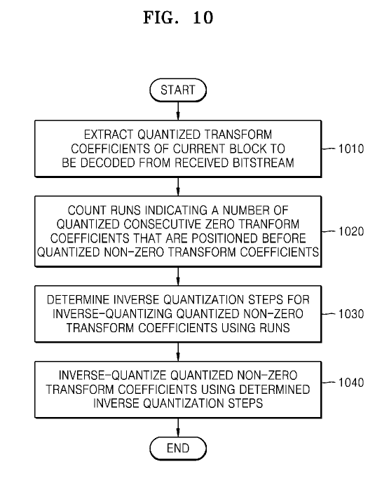

FIG. 10 is a flowchart of an inverse quantization method according to an exemplary embodiment of the present invention. Referring to FIG. 10, in operation 1010, quantized transform coefficients of a current block to be decoded is extracted from a received bitstream.

In operation 1020, runs indicating a number of quantized consecutive zero transform coefficients are counted. Here, the quantized consecutive zero transform coefficients are positioned before quantized non-zero transform coefficients of the quantized transform coefficients, i.e., significant transform coefficients.

In operation 1030, inverse quantization steps for inverse-quantizing the significant transform coefficients are determined using the counted runs. The inverse quantization steps may be determined to be proportional to lengths of the runs as described above, may be calculated using Equation 4 above, or may be determined by storing the inverse quantization steps in a table according to QPs and lengths of runs and then observing inverse-quantized transform coefficients to be coded next.

In operation 1040, the significant transform coefficients are inverse-quantized using the determined inverse quantization steps.

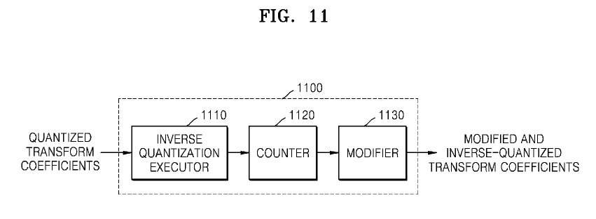

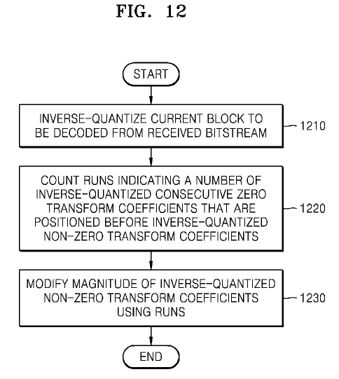

FIG. 11 is a block diagram of an inverse quantization apparatus according to another exemplary embodiment of the present invention. Referring to FIG. 11, an inverse quantization apparatus 1100 according to the present exemplary embodiment includes an inverse quantization executor 1110, a counter 1120, and a modifier 1130.

The inverse quantization executor 1110 inverse-quantizes quantized transform coefficients of a current block of a received bitstream and outputs the inverse-quantized transform coefficients. Here, the inverse quantization method may be one of various inverse quantization methods including a related art inverse quantization method using fixed inverse quantization steps, an inverse quantization method according to an exemplary embodiment of the present invention, etc.

The counter 1120 counts runs indicating a number of inverse-quantized consecutive zero transform coefficients that are positioned before significant transform coefficients of the inverse-quantized transform coefficients.

The modifier 1130 modifies sizes of the significant transform coefficients using the runs. Here, the modifier 1130 performs modification processes that are inverse to the processes of modifying sizes of significant transform coefficients, wherein the processes are performed by the modifier 540 of FIG. 5. In detail, the modifier 1130 adds values of runs to absolute values of inverse-quantized significant transform coefficients to modify the sizes of the inverse-quantized significant transform coefficients. For example, when the inverse-quantized transform coefficients output from the inverse quantization executor 1110 are arranged in “0 0 −2 7 0 0 0 0 0 . . . ,” length “2” of a previous run is added to an absolute value of a significant transform coefficient “−2” to modify the significant transform coefficient “−2” into “−4”. In the case of a significant transform coefficient “7,” a length of a run is “0”. Thus, the significant transform coefficient “7” is maintained as it is.

As described above, inverse-quantized transform coefficients having sizes modified according to lengths of previous runs are inverse-transformed as described above to restore an error value. As a result, the error value is added to a predictor to generate restored video.

FIG. 12 is a flowchart of an inverse quantization method according to another exemplary embodiment of the present invention. Referring to FIG. 12, in operation 1210, a current block that is decoded from a received bitstream is inverse-quantized. As described above, the inverse quantization method of the present embodiment may be performed using inverse quantization steps preset according to the related art quantization method or inverse quantization steps determined according to the inverse quantization method of the previous embodiment of the present invention.

In operation 1220, runs indicating a number of inverse-quantized consecutive zero transform coefficients are counted. Here, the inverse-quantized consecutive zero transform coefficients are positioned before significant transform coefficients of the inverse-quantized transform coefficients.

In operation 1230, sizes of the significant transform coefficients are modified using runs. As described above, lengths of previous runs may be added to absolute values of significant transform coefficients to modify sizes of the significant transform coefficients.

While the present invention has been particularly shown and described with reference to exemplary embodiments thereof, it will be understood by those of ordinary skill in the art that various changes in form and details may be made therein without departing from the spirit and scope of the present invention as defined by the following claims.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

What is claimed is:

1. A method of quantizing video comprising:
arranging transform coefficients of a transform block;
counting a length of a run for each non-zero transform coefficient, wherein the length of the run is a number of consecutive zero transform coefficients that are positioned before each of the non-zero transform coefficients of the arranged transform coefficients; and
determining quantization steps for quantizing each of the non-zero transform coefficients based on the length of the run for each of the non-zero transform coefficients.

2. The method of claim 1, wherein the quantization steps for quantizing the non-zero transform coefficients are proportional to the length of the run for each of the non-zero transform coefficients.

3. The method of claim 1, wherein a first quantization step (Q_{org}) quantizes the transform block according to quantization parameters (QPs), the length of the run (N) for each of the non-zero transform coefficients is a positive integer, “a” is a scaling factor, and a second quantization step Q_{new} is calculated using Equation below and determined as a final quantization step for quantizing the transform coefficients:
Q_{new}=(1+a)*N*Q_{org}.

4. The method of claim 3, wherein if the length of the run is “0”, the first quantization step is determined as the final quantization step for quantizing the transform coefficients.

5. The method of claim 1, further comprising adding binary information to a bitstream, wherein the binary information indicates whether the quantization is executed using the length of the run for each of the non-zero transform coefficient of the arranged transform coefficients in the unit of the transform block.

6. The method of claim 1, wherein the transform coefficients of the transform block comprises a size according to a scan order.

7. An apparatus for quantizing video comprising:
an arranger which arranges transform coefficients of a transform block;
a counter which counts a length of a run for each non-zero transform coefficient, wherein the length of the run is a number of consecutive zero transform coefficients that are positioned before each of the non-zero transform coefficients of the arranged transform coefficients; and
a quantization step determiner which determines quantization steps for quantizing the non-zero transform coefficients based on the length of the run for each of the non-zero transform coefficients.

8. The apparatus of claim 7, wherein the quantization step determiner which determines the quantization steps for quantizing the non-zero transform coefficients so that the quantization steps are proportional to the length of the run for each of the non-zero transform coefficients.

9. The apparatus of claim 7, wherein a first quantization step (Q_{org}) quantizes the transform block according to quantization parameters (QPs), the length of the run (N) for each of the non-zero transform coefficients is a positive integer, “a” is a scaling factor, and the quantization step determiner which calculates a second quantization step (Q_{new}) using Equation below, determines the second quantization step as a final quantization step for quantizing the transform coefficients, and determines the first quantization step as the final quantization step if the length of the run is “0”:
Q_{new}=(1+a)*N*Q_{org}.

10. The apparatus of claim 7, wherein the transform coefficients of the transform block comprises a size according to a scan order.

11. A method of quantizing video comprising:
arranging quantized transform coefficients of a quantized transform block according to a scan order;
counting a length of a run for each quantized non-zero transform coefficient, wherein the length of the run is a number of quantized consecutive zero transform coefficients that are positioned before each of the quantized non-zero transform coefficients of the arranged quantized transform coefficients; and
modifying each of the quantized non-zero transform coefficients based on the length of the run for each of the quantized non-zero transform coefficients.

12. The method of claim 11, wherein the modifying each of the quantized non-zero transform coefficients comprises:
subtracting the length of the run for each of the quantized non-zero transform coefficients from absolute values of each of the quantized non-zero transform coefficients; and
determining the subtraction result values as modified values of the quantized non-zero transform coefficients.

13. The method of claim 12, wherein if the subtraction result values are negative, the quantized non-zero transform coefficients are modified to “0”.

14. An apparatus for quantizing video comprising:
an arranger which arranges quantized transform coefficients of a quantized transform block according to a scan order;
a counter which counts a length of a run for each quantized non-zero transform coefficient, wherein the length of the run is a number of quantized consecutive zero transform coefficients that are positioned before quantized non-zero transform coefficients of the arranged quantized transform coefficients; and
a modifier which modifies each of the quantized non-zero transform coefficients based on the length of the run for each of the quantized non-zero transform coefficients.

15. The apparatus of claim 14, wherein the modifier subtracts the length of the run for each of the quantized non-zero transform coefficients from absolute values of each of the quantized non-zero transform coefficients and determines the subtraction result values as modified values of the quantized non-zero transform coefficients.

16. The apparatus of claim 15, wherein if the subtraction result values are negative, the modifier modifies the quantized non-zero transform coefficients to “0”.

17. A method of inverse-quantizing video comprising:
extracting quantized transform coefficients of a current block to be decoded from a received bitstream;
counting a length of a run for each quantized non-zero transform coefficient, wherein the length of the run is a number of quantized consecutive zero transform coefficients that are positioned before each of the quantized non-zero transform coefficients of the quantized transform coefficients;
determining inverse quantization steps for inverse-quantizing the quantized non-zero transform coefficients, using the length of the run for each of the quantized non-zero transform coefficients; and
inverse-quantizing the quantized non-zero transform coefficients using the determined inverse quantization steps.

18. The method of claim 17, wherein the inverse quantization steps for inverse-quantizing the quantized non-zero transform coefficients are determined to be proportional to the length of the run for each of the quantized non-zero transform coefficients.

19. The method of claim 17, wherein a first inverse quantization step (IQ_{org}) inverse-quantizes the transform block according to quantization parameters (QPs), the length of the run (N) for each of the quantized non-zero transform coefficients is a positive integer, “a” is a scaling factor, and a second inverse quantization step IQ_{new} is calculated using Equation below and determined as a final inverse quantization step for inverse-quantizing the quantized transform coefficients:
IQ_{new}=(1+a)*N*IQ_{org}.

20. The method of claim 19, wherein if the length of the run is “0”, the first inverse quantization step is determined as the final inverse-quantization step for inverse-quantizing the quantized transform coefficients.

21. A method of inverse-quantizing video comprising:
inverse-quantizing a current block to be decoded from a received bitstream;
counting a length of a run for each inverse-quantized non-zero transform coefficient, wherein the length of the run is a number of inverse-quantized consecutive zero transform coefficients that are positioned before each of the inverse-quantized non-zero transform coefficients of the inverse-quantized transform coefficients; and
modifying each of the inverse-quantized non-zero transform coefficients based on the length of the run for each of the inverse-quantized non-zero transform coefficients.

22. The method of claim 21, wherein the modifying each of the inverse-quantized non-zero transform coefficients comprises adding the length of the run for each of the inverse-quantized non-zero transform coefficients to absolute values of the inverse-quantized non-zero transform coefficients.
